(19) United States
(12) Patent Application Publication
(10) Pub. No.: US 2012/0053995 A1
(43) Pub. Date: Mar. 1, 2012

(54) ANALYZING PERFORMANCE AND SETTING STRATEGIC TARGETS

(76) Inventors: JOHN D'ALBIS, NORTH EASTON, MA (US); ANIL JOSE, QUINCY, MA (US); DAVID ASKWYTH, HAMILTON, MA (US)

(21) Appl. No.: 12/871,952

(22) Filed: Aug. 31, 2010

(51) Int. Cl. G06Q 10/00

(52) U.S. Cl. 705/7.39

(57) ABSTRACT

Various embodiments of systems and methods for analyzing performance and setting strategic targets for an objective of an organization on a GUI are described herein. One or more KPI values associated with an objective of an organization for each time period over a predetermined time interval are retrieved. A plurality of index values representing one or more KPI score ranges for the objective are received. Further, probability percentage of each KPI score range for each time period and for a successive time period are determined based on the retrieved one or more KPI values using a distribution function. At least one of the determined probability percentages for each time period and the successive time period are displayed on the GUI in form of a plurality of graphical bins indicating performance trend of the objective and percent chance of achieving a target range.

### FIELD

Embodiments generally relate to computer systems, and more particularly to methods and systems for analyzing performance and setting strategic targets for an objective of an organization on a computer generated graphical user interface (GUI).

### BACKGROUND

Strategy management is one example of a number of applications designed to manage and improve performance of an organization with a focus on topics related to strategy. It provides overall direction to the organization that will enable the organization to achieve its strategic objectives. A scorecard is often used to evaluate the overall performance of the organization. Generally, the scorecard facilitates viewing the organization from different perspectives. Each perspective may have one or more objectives and corresponding metrics to measure its performance. The metrics are called key performance indicators (KPI) or key success indicators (KSI). The KPIs are metrics utilized to visualize status and trends of the objectives of the organization.

Once the organization defines its objectives, KPIs can be employed to measure progress towards the objectives. In general, each KPI can have a target value and an actual value. Actual values can be compared with target values to determine score or target deviation, which further determines business' progress towards the target value. Therefore, KPIs are advantageous as they provide a clear description of organizational progress. However, one or more problems with the graphical representation of KPIs on the scoreboard have been identified in practice.

Currently, the graphical representation of KPIs on a GUI fails to provide information about the inherent variable nature of the KPIs, which affects the evaluation of the performance of the objective. Furthermore, setting accurate targets presents a challenge since it is often done in such a way, or using such tools, that the user information about previous trends and statistics therein are not fully provided. Without good targets, the determined score is less meaningful. In other words, KPIs provide information of where the organization stands today through the indication of the score. However, the organization is not typically provided with any statistical analysis of the future or successive time periods from the existing KPI values. Therefore, it would be desirable to graphically display the KPIs to analyze performance trend towards achieving the objective of the organization. Also, it would be desirable to preview the probability of achieving goals of the objective in the successive time periods with the existing KPI information which helps in setting strategic targets for the successive time periods.

### SUMMARY

Various embodiments of systems and methods for analyzing performance and setting strategic targets for an objective of an organization on a computer generated GUI are described herein. One or more key performance indicator (KPI) values associated with an objective of an organization for each time period over a predetermined time interval are retrieved. A plurality of index values representing one or more KPI score ranges for the objective are received. Further, probability percentage of each KPI score range for each time period and for a successive time period are determined based on the retrieved one or more KPI values using a distribution function. At least one of the determined probability percentages for each time period and the successive time period are displayed on the GUI using a plurality of graphical bins indicating performance trend of the objective and percent chance of achieving a target range respectively.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a flow diagram illustrating a process for displaying probability percentage of each KPI score range for each time period over a predetermined time period and a successive time period, according to an embodiment.

FIG. 2 is a schematic diagram of an exemplary GUI displaying a scorecard for analyzing performance trend of an objective, according to an embodiment.

FIG. 3 is a graphical representation of a normal distribution curve illustrating distribution of probability across a plurality of index values, according to an embodiment.

FIG. 4 is a schematic diagram of an exemplary GUI displaying probability percentage of each KPI score range for a successive time period, according to an embodiment.

FIG. 5 is a schematic diagram of an exemplary GUI displaying forecast information for a successive time period, according to an embodiment.

FIG. 6 is a block diagram illustrating a computing environment in which the techniques described for analyzing performance and setting strategic targets can be implemented, according to an embodiment.

### DETAILED DESCRIPTION

Embodiments of techniques for methods and systems for analyzing performance and setting strategic targets for an objective of an organization on a computer generated GUI are described herein. In strategy management, the organization is viewed from various perspectives such as learning and growth perspective, business process perspective, customer perspective, financial perspective and the like. A perspective is an indicator for various aspects of a business where the organization needs to focus to execute its strategy. Each perspective contains one or more objectives and each objective is measured through key performance indicators (KPIs). For example, in a fashion enterprise or organization, ‘customer’ perspective may have objectives such as ‘be a trusted advisor for fashion’, ‘become a destination store for high-quality stylish accessories’ and the like. The ‘financial’ perspective may have objectives such as ‘increase share of wallet of target audience’, ‘maintain consistent sales growth’ and the like. Similarly, other perspectives have one or more objectives as per the organization views. Further, a scorecard is used to provide detailed summary analysis of the KPIs, wherein the scorecard provides visualization of the objectives and their KPIs in hierarchies under their respective perspectives.

The KPIs are specified indicators of organizational performance that measure a current state in relation to meeting the targeted objectives. The KPI can be measured at regular time periods such as weekly, monthly, quarterly, annually and the like. KPI values for each time period include measure of an actual value, a target value, a score or a target deviation, a mean deviation and the like, which represents the performance of the objective. The target value represents a quantitative goal towards the objective that is considered key to the success of the organization. The actual value represents a quantitative value achieved for the specific time period. The other KPI measures such as the score, the mean deviation and the like are calculated as a function of the actual value and the target value.

One or more KPI values of an objective for each time period of a predetermined time period and one or more KPI score ranges are received. The predetermined time period include one or more past time periods and a present time period. Further, probability percentage of each KPI score range for each time period is determined and is displayed on the GUI using a plurality of graphical bins. The graphical display of the probability percentage of each KPI score range using the graphical bins facilitates analyzing the performance trend towards achieving the objective. In other words, the graphical representation of the graphical bins visually enhances the analysis of the trend towards achieving the objective in the predetermined time period. For example, even though the measure of score indicates an ‘acceptable’ value, there is a probability that the score is towards ‘warranting a warning’. This information is represented by the graphical bins to help decision makers of strategy management to decide upon strategy towards achieving the objective.

Also, the probability percentage of each score range for the successive time period is determined using the existing KPI values of predetermined time period and the same is displayed on the GUI using the plurality of graphical bins. The index values can be changed by a user to monitor the percent change of each KPI score range. Thereby, a feedback is provided to the user as to how realistic a set of score ranges can be achieved and thus facilitates to strategically set the target for the successive time period. In addition, the feedback is provided to the user to set realistic target by providing forecast information for the successive time period using graphical bins. Each graphical bin is attributed with at least a format for displaying data. For example, each bin can be a bubble formatted with a specific color and the probability percentage is represented by the size of the graphical bins.

In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

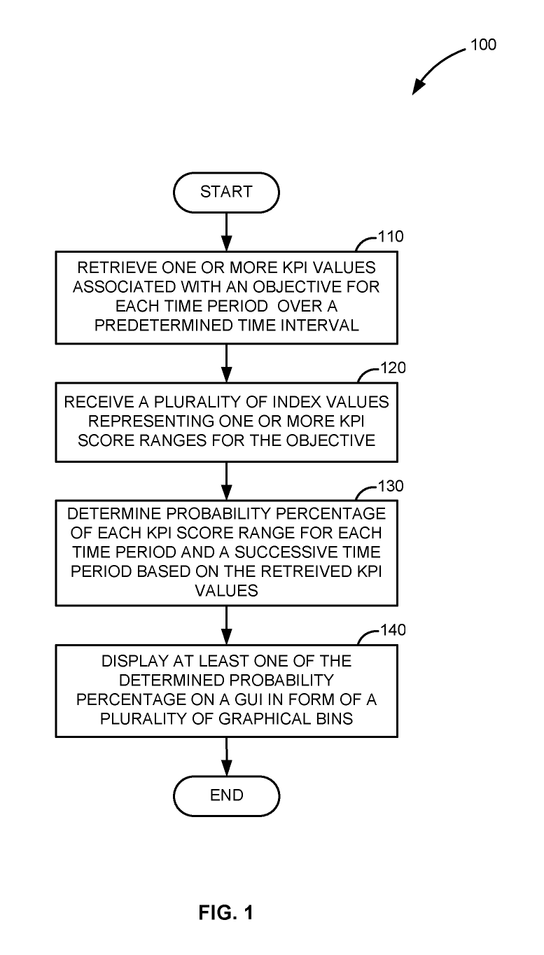

FIG. 1 is a flow diagram illustrating a process 100 for displaying probability percentage of each KPI score range for each time period over a predetermined time period and a successive time period, according to an embodiment. At step 110, one or more KPI values associated with an objective of an organization for each time period over the predetermined time interval are retrieved. The KPI values include metrics of an actual value, a target value, a score or a target deviation, and a mean deviation of each time period. The score and the mean deviation are calculated as a function of a corresponding actual value and target value, and wherein the actual value and the target value of each time period are retrieved from a database. The predetermined time interval comprises one or more past time periods and a present time period.

In step 120, a plurality of index values representing one or more KPI score ranges for the objective is received. In one embodiment, the index values are specified by a user for the objective on the GUI. At step 130, probability percentage of each KPI score range is determined for each time period and the successive time period based on the retrieved KPI values using distribution function. The probability percentage of each KPI score range for each time period is determined using a distribution function of the score and the mean deviation of each time period. The probability percentage of each KPI score range for the successive time period is determined using a distribution function of the scores of the predetermined time interval.

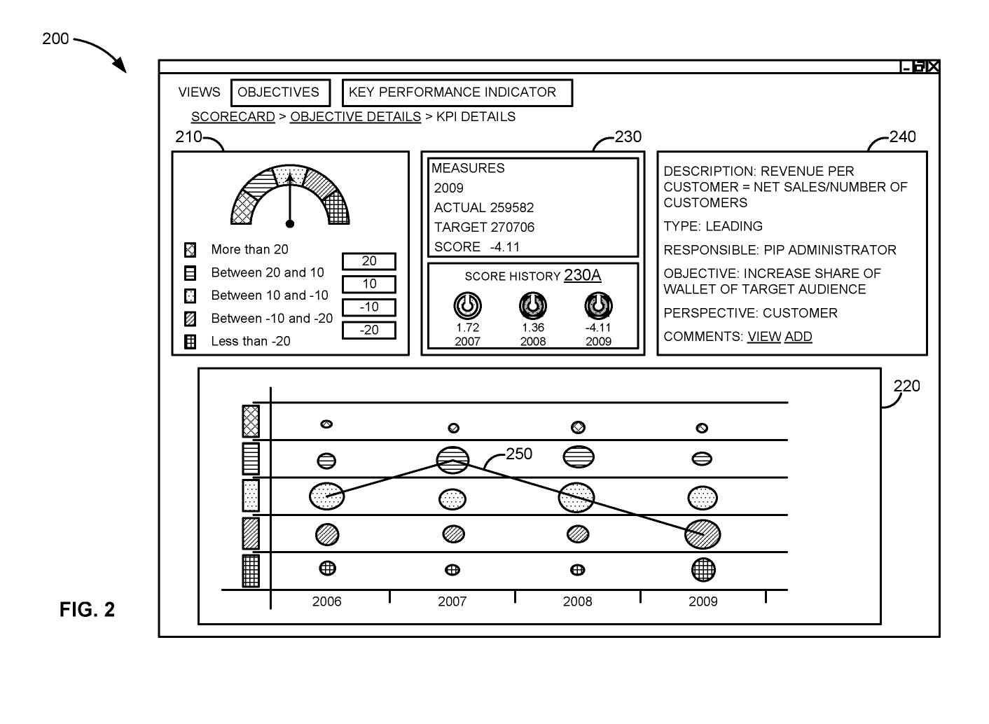

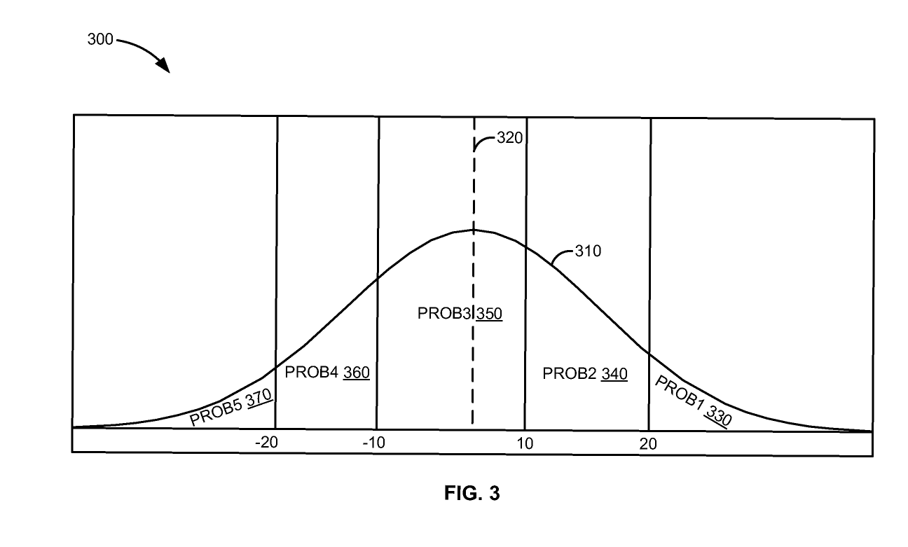

At step 140, the determined probability percentage for each time period and/or the successive time period are returned and displayed on a GUI in form of a plurality of graphical bins indicating performance trend of the objective and percent chance of achieving a target range respectively. In one example embodiment, size of each graphical bin represents the probability percentage. The determination of probability percentage for each time period and display of the same is explained in greater detail in FIG. 2 with an example. The determination of probability percentage for the successive time period and display of the same is described in greater detail in FIG. 3 with an example.

FIG. 2 is a schematic diagram of an exemplary GUI displaying a scorecard 200 for analyzing performance trend of an objective, according to an embodiment. The scorecard 200 includes an index value display area 210, a KPI score graphical display area 220, a KPI details display area 230, and an additional information display area 240. The index value display area 210 provides an option to a user to specify the index values, wherein the index values represent one or more KPI score ranges. In one exemplary embodiment, a symbol and/or pattern is used to represent each KPI score range. For example, a different pattern is used to represent each KPI score range as shown in the KPI index value display area 210. In another exemplary embodiment, each KPI score range can be associated with a color to indicate the associated KPI score range. The number of score ranges can vary with embodiments.

In one embodiment, KPI values associated with the objective (for example, “increase share of wallet of target audience”) of a fashion organization for each time period over a predetermined time interval 2006 to 2009 are retrieved as shown in Table 1. In one exemplary embodiment, the KPI values include metrics of an actual value, a target value, a score or target deviation, and a mean deviation for each time period.

TABLE 1

| | Year | | | |
|---|---|---|---|---|
| | 2006 | 2007 | 2008 | 2009 |
| Actual | 189382 | 203419 | 253691 | 259582 |
| Target | 195356 | 199984 | 250296 | 270706 |
| Trend | 189382 | 196401 | 215497 | 238897 |
| Mean Deviation | −3.06 | −1.79 | −13.90 | −11.75 |
| (MEANDEV) | | | | |
| Score or Target | −3.06 | 1.72 | 1.36 | −4.11 |
| Deviation (TARDEV) | | | | |

In one exemplary embodiment, the actual values and the target values are retrieved from the database. In some embodiments, the mean deviation is calculated using an equation ((Trend−Target)/Target)×100, wherein the trend is the moving average of the actual values. In other words, the trend is calculated by an average of the actual value of a particular time period and the actual value of the past time periods. In some embodiments, the operands in the numerator are reversed. In some embodiments, the absolute value of the subtract result is taken. The target deviation or score is calculated using an equation ((Actual−Target)/Target)×100. It is appreciated that the equation to calculate target deviation or score can be customized depending on the type of the objective. For example, to calculate achievement percentage, the equation used is (Actual/Target)×100. To calculate reduction percentage, the equation used is ((Actual—Target)/Target)×100. To calculate absolute percentage, the equation used is 100−((|Actual−Target)/Target)×100). To calculate zero target, the equation used is Actual−Target. Further, each KPI score range as specified by a user through index values in the index value display area 210 is received. For example, the index values 20, 10, −10, and −20 are received. Furthermore, with the retrieved KPI values and the KPI score range set by the user on the GUI, the probability of each KPI score range is shown by an area under the normal distribution curve, which is described in greater detail in FIG. 3.

In an embodiment, the determined probability percentage for each time period is displayed in the KPI score graphical display area 220 in form of a plurality of graphical bins indicating performance trend 250 of the KPI score of the objective. Each bin is placed at the appropriate location in a graph with x-axis representing each time period 2006 to 2009 as shown in the KPI score graphical display area 220. In one embodiment, size of each graphical bin represents the determined probability percentage. Therefore, the user is provided with a view over time showing how the scorecard 200 values are changed, which facilitates analyzing performance of the organization with respect to the objective.

In addition, the KPI details display area 230 displays one or more KPI values for the desired time period. For example, the KPI details display area 230 displays the KPI values for the year 2009 for the quick reference of the user. In addition, the KPI display area 230 includes a score history area 230A, wherein KPI scores of one or more recent time periods (e.g., 2007 to 2009) are displayed graphically. For example, graphical representation of the KPI scores as per the KPI score ranges indicating whether the associated value is acceptable (a circle with a line extending from the center to the left, graphically between 6 o'clock and 12 o'clock), warranting a warning (a circle with a line extending from the center, graphically, at 12 o'clock), or unacceptable (a circle with a line extending from the center to the right, graphically between 6 o'clock and 12 o'clock). Further, the graphical representation can also be associated with a color, for example, dark green to yellow to dark red as specified for each KPI score range. In another exemplary embodiment, various other graphical indicators and color schemes may be used to indicate the associated KPI score range. Furthermore, the additional display area 240 provides additional information such as ‘description’ of the objective, whether the performance is lagging or leading through ‘type’, ‘responsible person’, ‘objective’, ‘perspective’ and the like. In addition, views can be added through a ‘comments’ option as in the standard scoreboard.

FIG. 3 is a graphical representation 300 of a normal distribution curve 310 illustrating distribution of probability across a plurality of index or threshold values (for example, −20, −10, 10 and 20), according to an embodiment. The normal distribution curve 310 is bell shaped, with peak at the mean deviation (MEANDEV) 320. The probability (PROB) of each KPI score range is shown by an area under the normal distribution curve 310. For example, PROB1 330 is the probability of the KPI being greater than 20, PROB2 340 is the probability of the KPI being between the range of 10 and 20, PROB3 350 is between the range of −10 and 10, PROB4 360 is between the range of −20 and −10, and PROB5 370 is less than −20. The probabilities are calculated as follows:

$$PROB 1 = 1 - \frac{1}{2} [ 1 + erf ( \frac{20 - μ}{\sqrt{2 {σ}^{2}}} ) ]$$

$$PROB 2 = \frac{1}{2} [ 1 + erf ( \frac{20 - μ}{\sqrt{2 {σ}^{2}}} ) ] - \frac{1}{2} [ 1 + erf ( \frac{10 - μ}{\sqrt{2 {σ}^{2}}} ) ]$$

$$PROB 3 = \frac{1}{2} [ 1 + erf ( \frac{10 - μ}{\sqrt{2 {σ}^{2}}} ) ] - \frac{1}{2} [ 1 + erf ( \frac{( - 10 ) - μ}{\sqrt{2 {σ}^{2}}} ) ]$$

$$PROB 4 = \frac{1}{2} [ 1 + erf ( \frac{( - 10 ) - μ}{\sqrt{2 {σ}^{2}}} ) ] - \frac{1}{2} [ 1 + erf ( \frac{( - 20 ) - μ}{\sqrt{2 {σ}^{2}}} ) ]$$

$$PROB 5 = \frac{1}{2} [ 1 + erf ( \frac{( - 20 ) - μ}{\sqrt{2 {σ}^{2}}} ) ]$$

wherein, the cumulative distribution function (also called Gauss error function),

$$\frac{1}{2} [ 1 + erf ( \frac{x - μ}{\sqrt{2 {σ}^{2}}} ) ]$$

is used to determine the probability, wherein MEANDEV is used for μ, σ is the standard deviation of score or target deviation (TARDEV) and x is the index value. The determined probabilities for each KPI score range for each time period is shown in Table 2. Further, the determined probability percentage for each time period is displayed in form of a plurality of graphical bins indicating performance trend of the KPI score of the objective as described in FIG. 2.

TABLE 2

Year

| | 2006 | 2007 | 2008 | 2009 |
|---|---|---|---|---|
| MEANDEV | −3.06 | −1.79 | −13.90 | −11.75 |
| Score or | −3.06 | 1.72 | 1.36 | −4.11 |
| TARDEV | | | | |
| PROB1 | 0.0421 | 0.0513 | 0.0055 | 0.0087 |
| PROB2 | 0.1219 | 0.5421 | 0.3101 | 0.0429 |
| PROB3 | 0.5345 | 0.1830 | 0.3483 | 0.2839 |
| PROB4 | 0.1993 | 0.1372 | 0.2911 | 0.3962 |
| PROB5 | 0.1022 | 0.0863 | 0.3239 | 0.2683 |

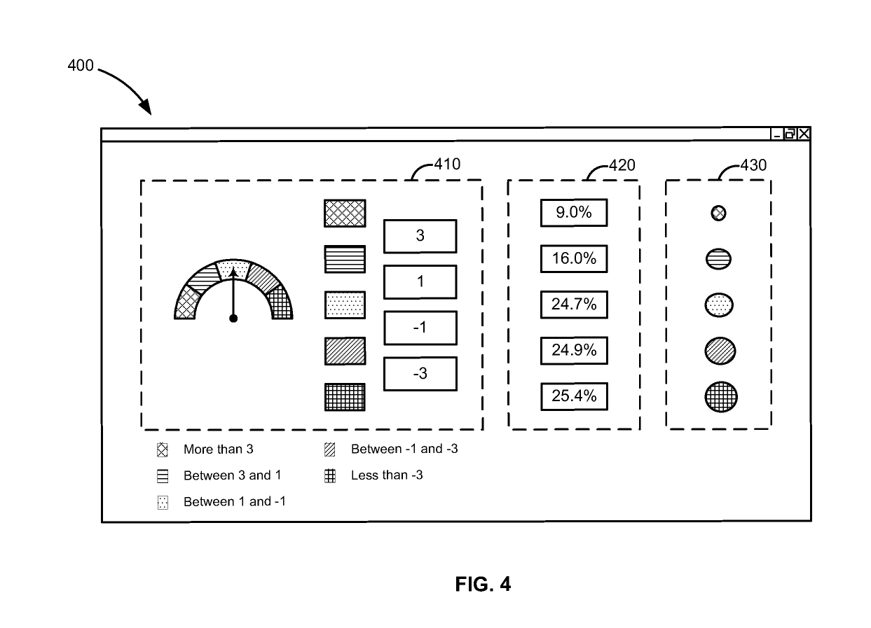

FIG. 4 is a schematic diagram of an exemplary GUI 400 displaying probability percentage of each KPI score range for a successive time period, according to an embodiment. The GUI 400 includes an index value display area 410, a probability percentage display area 420 and a graphical display area 430. The index value display area 410 provides an option to a user to specify the index values, wherein each index value represents one or more KPI score ranges. For example, 3, 1, −1 and −3 are specified as index values, wherein above 3, between 3 to 1, between 1 to −1, between −1 to −3 and below −3 are considered as KPI score ranges. In one exemplary embodiment, one or more symbols and/or patterns are used to represent each KPI score range. For example, a different pattern is used to represent each KPI score range as shown in the KPI index value display area 410. In another exemplary embodiment, each KPI score range can be associated with a color to indicate the associated KPI score range.

In one embodiment, KPI values associated with the objective (for e.g., “increase share of wallet of target audience” as detailed with respect to FIG. 2) of an organization for each time period over a predetermined time interval from 2006 to 2009 are retrieved as shown in Table 3.

TABLE 3

| | Year | | | |
|---|---|---|---|---|
| | 2006 | 2007 | 2008 | 2009 |
| Actual | 189382 | 203419 | 253691 | 259582 |
| Target | 195356 | 199984 | 250296 | 270706 |
| Score or Target | −3.06 | 1.72 | 1.36 | −4.11 |
| Deviation (TARDEV) | | | | |

In one embodiment, with the available KPI values over a predetermined time interval, i.e., from 2006 to 2009, probability percentage of each KPI score range is determined using distribution function having the built-in normal distribution function,

$$\frac{1}{\sqrt{2 {πσ}^{2}}} {e}^{- \frac{{( x - μ )}^{2}}{2 {σ}^{2}}}$$

wherein μ is the mean of the score from 2006 to 2009 and σ is the standard deviation of the mean having built in function

$$\sqrt{\frac{{\sum }_{n = 1}^{N} {( {TARDEV}_{n} - μ )}^{2}}{N - 1}} .$$

The probability percentage of each KPI score range for the successive time period 2010 is displayed in the probability percentage display area 420 and the same is displayed graphically in form of a plurality of graphical bins as shown in the graphical display area 430. In one embodiment, size of each graphical bin represents the determined probability percentage. Further, the user can change the index values on the GUI 400 to view the percent change of the score would be achieved for the successive time period 2010. Thereby, a feedback is provided to the user as to how a target can be set for the successive time period. In other words, by providing means to visually see the effect on the probability distribution of adjusting the KPI score ranges, the user would be able to create a better target range for the successive time period.

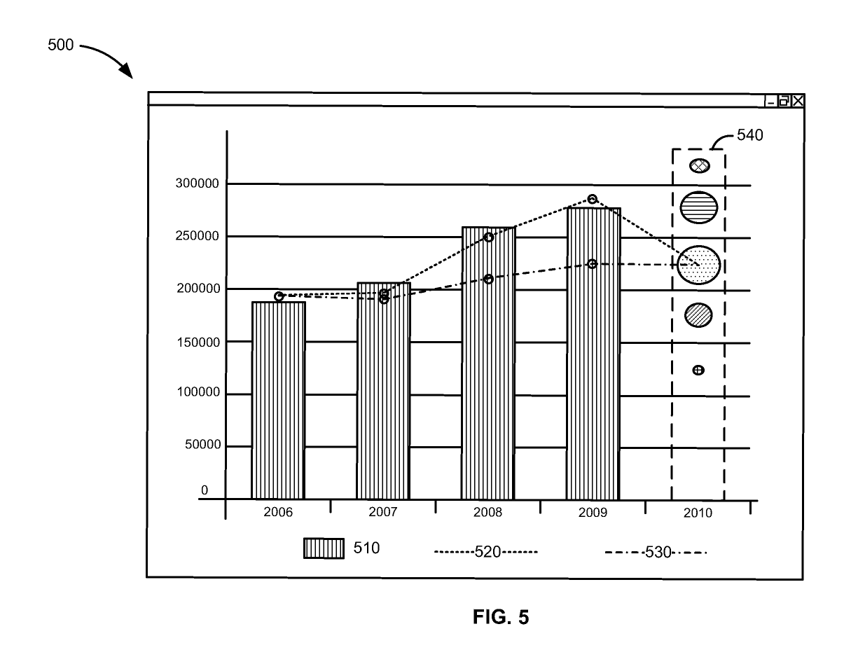

FIG. 5 is a schematic diagram of an exemplary GUI 500 displaying forecast information for a successive time period, according to an embodiment. The similar concept described with respect to FIG. 4 is used to display the forecast information for the successive time period 2010. In an embodiment, the probability percentage of achieving an objective for the successive time period 2010 is determined using the available KPI values such as actual values from the year 2006 to 2009 through the normal distribution function

$$\frac{1}{\sqrt{2 {πσ}^{2}}} {e}^{- \frac{{( x - μ )}^{2}}{2 {σ}^{2}}} ,$$

wherein μ is the mean of actual values from 2006 to 2009 and σ is the standard deviation of the mean having built in function

$$\sqrt{\frac{{\sum }_{n = 1}^{N} {( {Actual}_{n} - μ )}^{2}}{N - 1}} .$$

Further, the percentage probability of achieving the objective for the successive time period 2010 is displayed on the GUI 500 in form of the plurality of bins. A graph is plotted having time period as x-axis and a quantitative actual value in the y-axis. Actual values 510 and target values 520 for the years 2006 to 2009 are represented in the graph. Further, a trend 530, i.e., a moving average of the actual is also represented. The actual values, the target values and the calculated trend from the time period 2006 to 2009 is depicted in Table 4. The forecast information for the successive time period 2010 is displayed using the plurality of bins as shown as 540. Each bin is displayed corresponding to the quantitative data with size of each graphical bin representing the probability percentage of achievement. Thus, the forecast information for the successive time period 2010 is displayed, which helps the decision makers to set realistic and meaningful targets for the successive time period.

TABLE 4

Year

| | 2006 | 2007 | 2008 | 2009 |
|---|---|---|---|---|
| Actual | 189382 | 203419 | 253691 | 259582 |
| Target | 195356 | 199984 | 250296 | 270706 |
| Trend | 189382 | 196401 | 215497 | 238897 |

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components may be implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

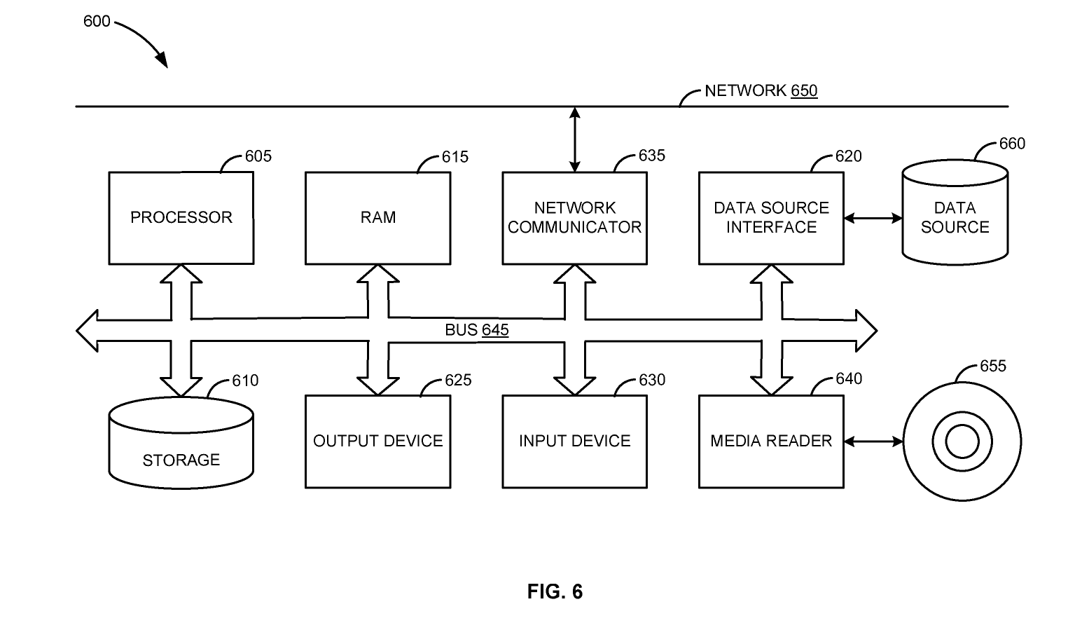

FIG. 6 is a block diagram of an exemplary computer system 600. The computer system 600 includes a processor 605 that executes software instructions or code stored on a computer readable storage medium 655 to perform the above-illustrated methods of the invention. The computer system 600 includes a media reader 640 to read the instructions from the computer readable storage medium 655 and store the instructions in storage 610 or in random access memory (RAM) 615. The storage 610 provides a large space for keeping static data where at least some instructions could be stored for later execution. The stored instructions may be further compiled to generate other representations of the instructions and dynamically stored in the RAM 615. The processor 605 reads instructions from the RAM 615 and performs actions as instructed. According to one embodiment of the invention, the computer system 600 further includes an output device 625 (e.g., a display) to provide at least some of the results of the execution as output including, but not limited to, visual information to users and an input device 630 to provide a user or another device with means for entering data and/or otherwise interact with the computer system 600. Each of these output devices 625 and input devices 630 could be joined by one or more additional peripherals to further expand the capabilities of the computer system 600. A network communicator 635 may be provided to connect the computer system 600 to a network 650 and in turn to other devices connected to the network 650 including other clients, servers, data stores, and interfaces, for instance. The modules of the computer system 600 are interconnected via a bus 645. Computer system 600 includes a data source interface 620 to access data source 660. The data source 660 can be accessed via one or more abstraction layers implemented in hardware or software. For example, the data source 660 may be accessed by network 650. In some embodiments the data source 660 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in detail to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. An article of manufacture including a computer readable storage medium to tangibly store instructions, which when executed by a computer, cause the computer to:
retrieve one or more key performance indicator (KPI) values associated with an objective of an organization for each time period over a predetermined time interval;
receive a plurality of index values representing one or more KPI score ranges for the objective;
determine probability percentage of each KPI score range for each time period and a successive time period based on the retrieved one or more KPI values using a distribution function; and
return at least one of the determined probability percentage for each time period and the successive time period to indicate performance trend of the objective and percent chance of achieving a target range.

2. The article of manufacture of claim 1, wherein the one or more KPI values comprise metrics of an actual value, a target value, a score, and a mean deviation of each time period.

3. The article of manufacture of claim 2, wherein the score and the mean deviation are calculated as a function of a corresponding actual value and target value, and wherein the actual value and the target value for each time period are retrieved from a database.

4. The article of manufacture of claim 3, wherein the probability percentage of each KPI score range for each time period is determined using the distribution function of the score and the mean deviation of each time period.

5. The article of manufacture of claim 3, wherein the probability percentage of each KPI score range for the successive time period is determined using the distribution function of the scores of the predetermined time interval.

6. The article of manufacture of claim 5, wherein the predetermined time interval comprises one or more past time periods and a present time period.

7. The article of manufacture of claim 1, wherein size of each graphical bin of the plurality of graphical bins represent the probability percentage.

8. The article of manufacture of claim 1, wherein the index values are specified by a user for the objective on a graphical user interface (GUI).

9. The article of manufacture of claim 1, further comprises instructions, which when executed by the computer, cause the computer to:
determine probability percentage of achieving the objective for the successive time period; and
display the determined probability percentage as a forecast information for the successive time period on a graphical user interface (GUI) using the plurality of graphical bins.

10. A computerized method for analyzing performance and setting strategic target on a graphical user interface (GUI), the method comprising:
retrieving one or more key performance indicator (KPI) values associated with an objective of an organization for each time period over a predetermined time interval;
receiving a plurality of index values representing one or more KPI score ranges for the objective;
determining probability percentage of each KPI score range for each time period and a successive time period based on the retrieved one or more KPI values using a distribution function; and
displaying at least one of the determined probability percentage for each time period and the successive time period on the GUI in form of a plurality of graphical bins indicating performance trend of the objective and percent chance of achieving a target range.

11. The computerized method of claim 10, wherein the one or more KPI values comprise metrics of an actual value, a target value, a score, and a mean deviation for each time period.

12. The computerized method of claim 11, wherein the score and the mean deviation are calculated as a function of a corresponding actual value and the target value, and wherein the actual value and the target value of each time period are retrieved from a database.

13. The computerized method of claim 12, wherein the probability percentage of each KPI score range for each time period is determined using the distribution function of the score and the mean deviation of each time period.

14. The computerized method of claim 12, wherein the probability percentage of each KPI score range for the successive time period is determined using the distribution function of the scores of the predetermined time interval.

15. The computerized method of claim 10, wherein the predetermined time interval comprises one or more past time periods and a present time period.

16. The computerized method of claim 10, wherein size of each graphical bin of the plurality of graphical bins represent the probability percentage.

17. The computerized method of claim 10, wherein the index values are specified by a user for the objective on the GUI.

18. The computerized method of claim 10, further comprises:
determining probability percentage of achieving the objective for the successive time period; and
displaying the determined probability percentage as a forecast information for the successive time period on the GUI using the plurality of graphical bins.

19. A computer system comprising a processor, the processor communicating with one or more memory devices storing instructions, the instructions operable to provide a graphical user interface (GUI), wherein the GUI is operable to:
retrieve one or more key performance indicator (KPI) values associated with an objective of an organization for each time period over a predetermined time interval;
receive a plurality of index values representing one or more KPI score ranges for the objective; and
determine probability percentage of each KPI score range of each time period over a predetermined time interval, of a successive time period and a forecast information for the successive time period based on the retrieved one or more KPI values using a distribution function, wherein the GUI comprises a scorecard to:
display index values for each KPI score range specified by a user for the objective in a KPI index value display area; and
display at least one of the determined probability of each time period over the predetermined time interval, determined probability of the successive time period, and the forecast information for the successive time period using a plurality of graphical bins.

20. The computerized system of claim 19, wherein the scorecard displays the plurality of graphical bins in different sizes and formats, wherein the size represents probability percentage, and wherein the format represents a KPI scores range.
